(19) United States
(12) Patent Application Publication
(10) Pub. No.: US 2023/0073221 A1
(43) Pub. Date: Mar. 9, 2023

(54) VARIABLE MAGNIFICATION OPTICAL SYSTEM, OPTICAL APPARATUS, AND METHOD FOR MANUFACTURING VARIABLE MAGNIFICATION OPTICAL SYSTEM

(71) Applicant: Nikon Corporation, Minato-ku, Tokyo (JP)

(72) Inventors: Kosuke MACHIDA, Tokyo (JP); Kyoya TOKUNAGA, Tokyo (JP)

(21) Appl. No.: 17/795,530

(22) PCT Filed: Jan. 12, 2021
(86) PCT No.: PCT/JP2021/000728

§ 371 Date: Jul. 26, 2022

(30) Foreign Application Priority Data
Jan. 29, 2020 (JP) 2020-012564
Jan. 29, 2020 (JP) 2020-012573

(51) Int. Cl. G02B 9/64; G02B 15/20

(52) U.S. Cl. CPC G02B 9/64; G02B 15/20

(57) ABSTRACT

A variable magnification optical system used in an optical apparatus is configured to include a plurality of lens groups such that upon varying magnification the distances between the lens groups are varied; a final lens group closest to an image side of the lens groups includes at least one lens surface having a pole; and the following conditional equation (1) or (2) is satisfied.

0.50<TL/fw<10.00 (1)

where TL denotes the shorter of the total optical length in a wide-angle end state and the total optical length in a telephoto end state of the variable magnification optical system, and fw denotes the focal length of the variable magnification optical system in the wide-angle end state.

−5.00<fRI/fR<5.00 (2)

where fRI denotes the focal length of a lens in the final lens group including a lens surface having a pole, and fR denotes the focal length of the final lens group.

### FIELD

The present invention relates to a variable magnification optical system, an optical apparatus, and a method for manufacturing a variable magnification optical system.

### BACKGROUND

Variable magnification optical systems used for cameras for photographs, electronic still cameras, video cameras and the like have been proposed (see, e.g., Patent Literature 1).

### CITATION LIST

### Patent Literature

Patent Literature 1: Japanese Unexamined Patent Publication No. 2004-198529

### SUMMARY

A variable magnification optical system of the present disclosure includes a plurality of lens groups; upon varying magnification the distances between the lens groups are varied; a final lens group closest to an image side of the lens groups includes at least one lens surface having a pole; and the following conditional equation is satisfied. A pole in the present disclosure refers to a point on a lens surface other than on an optical axis at which the optical axis crosses the tangent plane of the lens surface perpendicularly.

0.50<TL/fw<10.00

where

TL denotes the shorter of the total optical length in a wide-angle end state and the total optical length in a telephoto end state of the variable magnification optical system, and

fw denotes the focal length of the variable magnification optical system in the wide-angle end state.

A variable magnification optical system of the present disclosure includes a plurality of lens groups; upon varying magnification the distances between the lens groups are varied; a final lens group closest to an image side of the lens groups includes at least one lens surface having a pole; and the following conditional equation is satisfied:

−5.00<fRI/fR<5.00

where

fRI denotes the focal length of a lens in the final lens group including a lens surface having a pole, and

fR denotes the focal length of the final lens group.

A method for manufacturing a variable magnification optical system of the present disclosure is a method for manufacturing a variable magnification optical system including a plurality of lens groups. The method includes arranging the lens groups so that upon varying magnification the distances between the lens groups are varied; arranging so that a final lens group closest to an image side of the lens groups includes at least one lens surface having a pole; and arranging so that the following conditional equation is satisfied:

0.50<TL/fw<10.00

where

TL denotes the shorter of the total optical length in a wide-angle end state and the total optical length in a telephoto end state of the variable magnification optical system, and

fw denotes the focal length of the variable magnification optical system in the wide-angle end state.

### BRIEF DESCRIPTION OF DRAWINGS

FIG. 1 is a cross-sectional view of a variable magnification optical system of a first example.

FIG. 2A illustrates aberrations of the variable magnification optical system of the first example in the wide-angle end state.

FIG. 2B illustrates aberrations of the variable magnification optical system of the first example in an intermediate focal length state.

FIG. 2C illustrates aberrations of the variable magnification optical system of the first example in the telephoto end state.

FIG. 3 is a cross-sectional view of a variable magnification optical system of a second example.

FIG. 4A illustrates aberrations of the variable magnification optical system of the second example in the wide-angle end state.

FIG. 4B illustrates aberrations of the variable magnification optical system of the second example in an intermediate focal length state.

FIG. 4C illustrates aberrations of the variable magnification optical system of the second example in the telephoto end state.

FIG. 5 is a cross-sectional view of a variable magnification optical system of a third example.

FIG. 6A illustrates aberrations of the variable magnification optical system of the third example in the wide-angle end state.

FIG. 6B illustrates aberrations of the variable magnification optical system of the third example in an intermediate focal length state.

FIG. 6C illustrates aberrations of the variable magnification optical system of the third example in the telephoto end state.

FIG. 7 is a cross-sectional view of a variable magnification optical system of a fourth example.

FIG. 8A illustrates aberrations of the variable magnification optical system of the fourth example in the wide-angle end state.

FIG. 8B illustrates aberrations of the variable magnification optical system of the fourth example in an intermediate focal length state.

FIG. 8C illustrates aberrations of the variable magnification optical system of the fourth example in the telephoto end state.

FIG. 9 is a cross-sectional view of a variable magnification optical system of a fifth example.

FIG. 10A illustrates aberrations of the variable magnification optical system of the fifth example in the wide-angle end state.

FIG. 10B illustrates aberrations of the variable magnification optical system of the fifth example in an intermediate focal length state.

FIG. 10C illustrates aberrations of the variable magnification optical system of the fifth example in the telephoto end state.

FIG. 11 schematically illustrates a camera including a variable magnification optical system of the embodiment.

FIG. 12 is a schematic flowchart of a method for manufacturing a variable magnification optical system of the embodiment.

### DESCRIPTION OF EMBODIMENTS

The following describes a variable magnification optical system, an optical apparatus, and a method for manufacturing a variable magnification optical system of an embodiment of the present application.

A variable magnification optical system of the present embodiment includes a plurality of lens groups; upon varying magnification the distances between the lens groups are varied; and a final lens group closest to an image side of the lens groups includes at least one lens surface having a pole.

Such a configuration enables the variable magnification optical system of the present embodiment to correct aberrations favorably and achieving downsizing of the variable magnification optical system.

Additionally, the variable magnification optical system of the present embodiment satisfies the following conditional equation:

0.50<TL/fw<10.00 (1)

where

TL denotes the shorter of the total optical length in a wide-angle end state and the total optical length in a telephoto end state of the variable magnification optical system, and

fw denotes the focal length of the variable magnification optical system in the wide-angle end state.

The variable magnification optical system of the present embodiment can correct curvature of field favorably by making the ratio of the total optical length of the variable magnification optical system to the focal length of the variable magnification optical system in the wide-angle end state in conditional equation (1) greater than the lower limit. The effect of the present embodiment can be further ensured by setting the lower limit of conditional equation (1) at 0.50. To further ensure the effect of the present embodiment, the lower limit of conditional equation (1) is preferably set at 1.00, 1.25, 1.50, 1.75, 2.00, 2.25, 2.50, 2.75, or 3.00, more preferably at 3.10.

The variable magnification optical system of the present embodiment can correct aberrations favorably and be downsized by making the ratio of the total optical length of the variable magnification optical system to the focal length of the variable magnification optical system in the wide-angle end state in conditional equation (1) less than the upper limit. The effect of the present embodiment can be further ensured by setting the upper limit of conditional equation (1) at 10.00. To further ensure the effect of the present embodiment, the upper limit of conditional equation (1) is preferably set at 9.50, 9.00, 8.50, 8.00, 7.75, 7.50, 7.25, 7.00, 6.80, or 6.60, more preferably at 6.50.

A small-sized variable magnification optical system of favorable optical performance can be achieved by the above configuration.

Additionally, the variable magnification optical system of the present embodiment satisfies the following conditional equation:

−5.00<fRI/fR<5.00 (2)

where

fRI denotes the focal length of a lens in the final lens group including a lens surface having a pole, and

fR denotes the focal length of the final lens group.

Conditional equation (2) defines the ratio of the focal length of a lens in the final lens group including a lens surface having a pole to the focal length of the final lens group. The variable magnification optical system of the present embodiment satisfying conditional equation (2) can correct curvature of field favorably.

To further ensure the effect of the present embodiment, the lower limit of conditional equation (2) is preferably set at −4.50, −4.00, −3.75, −3.50, −3.25, −3.00, −2.75, −2.50, −2.00, −1.60, −1.30, −1.00, −0.50, −0.10, 0.10, or 0.30, more preferably at 0.50. To further ensure the effect of the present embodiment, the upper limit of conditional equation (2) is preferably set at 4.50, 4.00, 3.50, 3.00, 2.75, 2.50, 2.25, 2.00, 1.75, 1.50, 1.35, 1.20, or 1.15, more preferably at 1.10.

A small-sized variable magnification optical system of favorable optical performance can be achieved by the above configuration.

In the variable magnification optical system of the present embodiment, the lens groups preferably include at least one focusing lens group having positive refractive power and configured to move in the direction of an optical axis at focusing.

The variable magnification optical system of the present embodiment having such a configuration can reduce variations in curvature of field at focusing.

In the variable magnification optical system of the present embodiment, one of the at least one focusing lens group is preferably adjacent to the final lens group.

The variable magnification optical system of the present embodiment having such a configuration can reduce variations in curvature of field at focusing.

The variable magnification optical system of the present embodiment preferably satisfies the following conditional equation:

0.20<|fF/fR|<5.00 (3)

where

fF denotes the focal length of the focusing lens group adjacent to the final lens group, and

fR denotes the focal length of the final lens group.

The variable magnification optical system of the present embodiment can reduce the power of the focusing lens group and variations in coma aberration at focusing by making the ratio of the focal length of the focusing lens group adjacent to the final lens group to the focal length of the final lens group in conditional equation (3) greater than the lower limit. The effect of the present embodiment can be further ensured by setting the lower limit of conditional equation (3) at 0.20. To further ensure the effect of the present embodiment, the lower limit of conditional equation (3) is preferably set at 0.30, 0.40, 0.50, 0.60, 0.70, 0.75, 0.80, 0.85, 0.90, 0.93, 0.95, or 0.98, more preferably at 1.00.

The variable magnification optical system of the present embodiment can reduce the moving distance of the focusing lens group and variations in coma aberration at focusing by making the ratio of the focal length of the focusing lens group adjacent to the final lens group to the focal length of the final lens group in conditional equation (3) less than the upper limit. The effect of the present embodiment can be further ensured by setting the upper limit of conditional equation (3) at 5.00. To further ensure the effect of the present embodiment, the upper limit of conditional equation (3) is preferably set at 4.75, 4.50, 4.25, 4.00, 3.80, 3.60, or 3.50, more preferably at 3.40.

Preferably, the variable magnification optical system of the present embodiment further includes an aperture stop; the lens groups preferably include a front group including one or more lens groups closer to an object side than the aperture stop; a rear group placed closer to the image side than the aperture stop, including the focusing lens group, and having positive refractive power; and the final lens group placed closer to the image side than the rear group and having negative refractive power.

The variable magnification optical system of the present embodiment having such a configuration can reduce variations in aberrations at varying magnification.

Preferably, the variable magnification optical system of the present embodiment includes a plurality of lenses respectively including lens surfaces having a pole; of the lens surfaces having a pole, at least two lens surfaces are adjacent to each other with an air layer in between; and the radii of curvature of the two lens surfaces adjacent to each other with an air layer in between have the same sign on an optical axis.

The variable magnification optical system of the present embodiment having such a configuration can correct curvature of field favorably because of a difference in image height between adjacent lenses.

In the variable magnification optical system of the present embodiment, a final lens in the final lens group closest to the image side preferably includes a lens surface having a pole.

The variable magnification optical system of the present embodiment having such a configuration can correct curvature of field favorably because luminous flux is divided at the final lens according to image heights.

The variable magnification optical system of the present embodiment preferably satisfies the following conditional equation:

0.20<|fRI/fw|<5.00 (4)

where

fRI denotes the focal length of a lens in the final lens group including a lens surface having a pole.

The variable magnification optical system of the present embodiment satisfying conditional equation (4) can correct curvature of field and the like favorably. The effect of the present embodiment can be further ensured by setting the lower limit of conditional equation (4) at 0.20. To further ensure the effect of the present embodiment, the lower limit of conditional equation (4) is preferably set at 0.30, 0.40, 0.45, 0.50, 0.55, 0.60, 0.65, 0.70, 0.75, or 0.80, more preferably at 0.85.

The effect of the present embodiment can be further ensured by setting the upper limit of conditional equation (4) at 5.00. To further ensure the effect of the present embodiment, the upper limit of conditional equation (4) is preferably set at 4.80, 4.50, 4.35, 4.00, 3.85, 3.70, 3.50, 3.35, 3.10, 3.00, or 2.85, more preferably at 2.70.

In the variable magnification optical system of the present embodiment, one of the at least one lens surface in the final lens group having a pole preferably satisfies the following conditional equation:

0.10<k/h<1.00 (5)

where

k denotes the height of the pole from an optical axis, and

h denotes the effective radius of the lens surface having a pole.

The variable magnification optical system of the present embodiment satisfying conditional equation (5) can correct curvature of field and astigmatism favorably. The effect of the present embodiment can be further ensured by setting the lower limit of conditional equation (5) at 0.10. To further ensure the effect of the present embodiment, the lower limit of conditional equation (5) is preferably set at 0.20, 0.25, 0.30, 0.35, 0.40, 0.45, 0.50, 0.55, 0.60, 0.65, or 0.70, more preferably at 0.72.

The effect of the present embodiment can be further ensured by setting the upper limit of conditional equation (5) at 1.00. To further ensure the effect of the present embodiment, the upper limit of conditional equation (5) is preferably set at 0.99, 0.97, 0.95, 0.94, 0.93, or 0.92, more preferably at 0.90.

In the variable magnification optical system of the present embodiment, a lens surface closest to the image side of the at least one lens surface in the final lens group having a pole preferably satisfies the following conditional equation:

0.40<k/h<1.00. (6)

The variable magnification optical system of the present embodiment satisfying conditional equation (6) can correct curvature of field and astigmatism favorably. The effect of the present embodiment can be further ensured by setting the lower limit of conditional equation (6) at 0.40. To further ensure the effect of the present embodiment, the lower limit of conditional equation (6) is preferably set at 0.43, 0.45, 0.48, 0.50, 0.52, 0.54, 0.60, 0.65, 0.70, or 0.75, more preferably at 0.78.

The effect of the present embodiment can be further ensured by setting the upper limit of conditional equation (6) at 1.00. To further ensure the effect of the present embodiment, the upper limit of conditional equation (6) is preferably set at 0.99, 0.98, 0.97, 0.95, or 0.93, more preferably at 0.90.

The variable magnification optical system of the present embodiment preferably satisfies the following conditional equation:

0.10<BFw/fw<1.00 (7)

where

BFw denotes the back focus of the variable magnification optical system in the wide-angle end state.

The variable magnification optical system of the present embodiment facilitates disposing a mechanical member of a barrel by making the ratio of the back focus of the variable magnification optical system in the wide-angle end state to the focal length of the variable magnification optical system in the wide-angle end state in conditional equation (7) less than the lower limit. The effect of the present embodiment can be further ensured by setting the lower limit of conditional equation (7) at 0.10. To further ensure the effect of the present embodiment, the lower limit of conditional equation (7) is preferably set at 0.15, 0.18, 0.20, or 0.23, more preferably at 0.25.

The variable magnification optical system of the present embodiment can prevent increase in field curvature aberration caused by symmetry breaking of the optical system, by making the ratio of the back focus of the variable magnification optical system in the wide-angle end state to the focal length of the variable magnification optical system in the wide-angle end state in conditional equation (7) less than the upper limit. The effect of the present embodiment can be further ensured by setting the upper limit of conditional equation (7) at 1.00. To further ensure the effect of the present embodiment, the upper limit of conditional equation (7) is preferably set at 0.95, 0.90, 0.85, 0.80, 0.75, 0.70, 0.65, 0.60, or 0.55, more preferably at 0.50.

The variable magnification optical system of the present embodiment preferably satisfies the following conditional equation:

29.00<νR (8)

where

νR denotes the Abbe number of one of lenses in the final lens group including a lens surface having a pole.

The variable magnification optical system of the present embodiment can correct chromatic aberration favorably by making the value of conditional equation (8) greater than the lower limit. The effect of the present embodiment can be further ensured by setting the lower limit of conditional equation (8) at 29.00. To further ensure the effect of the present embodiment, the lower limit of conditional equation (8) is preferably set at 30.00, 33.00, 35.00, or 38.00, more preferably at 40.00.

The variable magnification optical system of the present embodiment preferably satisfies the following conditional equation:

29.00<νR1 (9)

where

νR1 denotes the Abbe number of a lens closest to the image side of lenses in the final lens group including a lens surface having a pole.

The variable magnification optical system of the present embodiment can correct chromatic aberration favorably by making the value of conditional equation (9) greater than the lower limit. The effect of the present embodiment can be further ensured by setting the lower limit of conditional equation (9) at 29.00. To further ensure the effect of the present embodiment, the lower limit of conditional equation (9) is preferably set at 30.00, 33.00, 35.00, or 38.00, more preferably at 40.00.

A small-sized variable magnification optical system of favorable optical performance can be achieved by the above configuration.

An optical apparatus of the present embodiment includes a variable magnification optical system having the above configuration. This enables achieving a small-sized optical apparatus of favorable optical performance.

A method for manufacturing a variable magnification optical system of the present embodiment is a method for manufacturing a variable magnification optical system including a plurality of lens groups. The method includes arranging the lens groups so that upon varying magnification the distances between the lens groups are varied; arranging so that a final lens group closest to an image side of the lens groups includes at least one lens surface having a pole; and arranging so that the following conditional equation (1) is satisfied:

0.50<TL/fw<10.00 (1)

where

TL denotes the shorter of the total optical length in a wide-angle end state and the total optical length in a telephoto end state of the variable magnification optical system, and

fw denotes the focal length of the variable magnification optical system in the wide-angle end state.

A small-sized variable magnification optical system of favorable optical performance can be manufactured by such a method for manufacturing a variable magnification optical system.

### NUMERICAL EXAMPLES

Examples of the present application will be described below with reference to the drawings.

### First Example

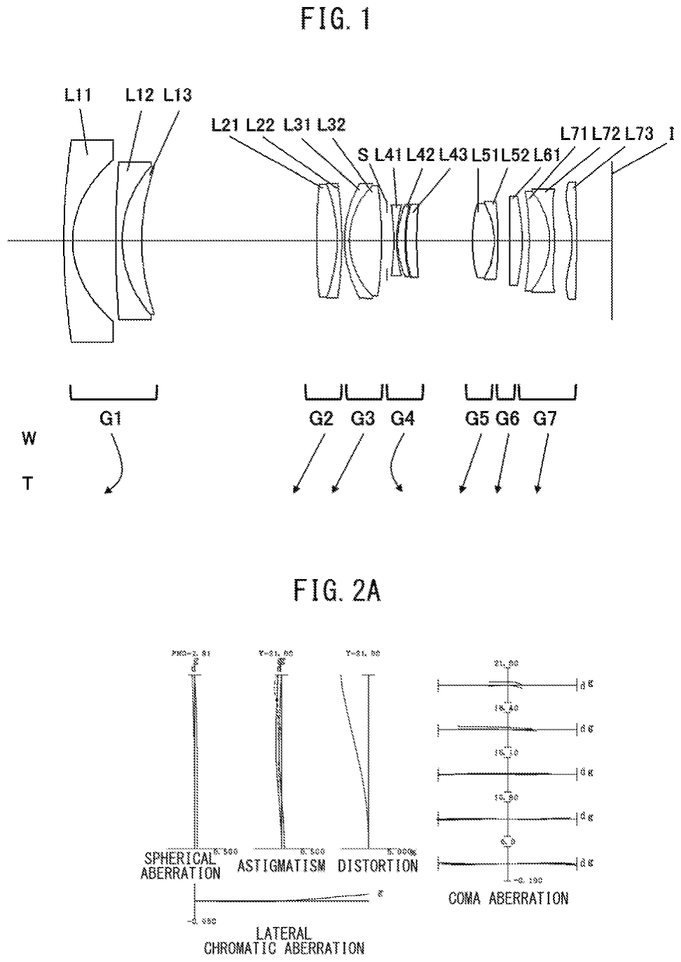

FIG. 1 is a cross-sectional view of a variable magnification optical system of a first example.

The variable magnification optical system of the present example includes a first lens group G1 having negative refractive power, a second lens group G2 having positive refractive power, a third lens group G3 having positive refractive power, a fourth lens group G4 having negative refractive power, a fifth lens group G5 having positive refractive power, a sixth lens group G6 having positive refractive power, and a seventh lens group G7 having negative refractive power, in order from an object side. The seventh lens group G7 is a final lens group closest to an image side of the lens groups. An aperture stop S is disposed between the third lens group G3 and the fourth lens group G4.

The first lens group G1 consists of a negative meniscus lens L11 convex on the object side and a positive cemented lens composed of a negative meniscus lens L12 convex on the object side and a positive meniscus lens L13 convex on the object side, in order from the object side.

The second lens group G2 consists of a positive cemented lens composed of a biconvex positive lens L21 and a negative meniscus lens L22 convex on the image side.

The third lens group G3 consists of a positive cemented lens composed of a negative meniscus lens L31 convex on the object side and a biconvex positive lens L32.

The fourth lens group G4 consists of a biconcave negative lens L41, a positive meniscus lens L42 convex on the object side, and a positive meniscus lens L43 convex on the object side.

The fifth lens group G5 consists of a positive cemented lens composed of a biconvex positive lens L51 and a negative meniscus lens L52 convex on the image side.

The sixth lens group G6 consists of a biconvex positive lens L61.

The seventh lens group G7 consists of a positive cemented lens composed of a positive meniscus lens L71 convex on the image side and a negative meniscus lens L72 convex on the image side as well as a negative meniscus lens L73 convex on the image side.

On an image plane I is disposed an imaging device (not shown) constructed from CCD, CMOS or the like.

Upon varying magnification from a wide-angle end state to a telephoto end state, the lens groups in the variable magnification optical system of the present example having the above configuration move along the optical axis so that the distance between the first lens group G1 and the second lens group G2, the distance between the second lens group G2 and the third lens group G3, the distance between the third lens group G3 and the fourth lens group G4, the distance between the fourth lens group G4 and the fifth lens group G5, the distance between the fifth lens group G5 and the sixth lens group G6, and the distance between the sixth lens group G6 and the seventh lens group G7 are varied. More specifically, the first lens group G1 moves to the image side temporarily and then to the object side. The fourth lens group G4 moves to the object side temporarily and then to the image side. The second lens group G2, the third lens group G3, the fifth lens group G5, the sixth lens group G6, and the seventh lens group G7 move to the object side.

The variable magnification optical system of the present example focuses by moving the fifth lens group G5 and the sixth lens group G6 as focusing lens groups along the optical axis. The sixth lens group G6, which is one of the focusing lens groups, is adjacent to the seventh lens group G7, which is the final lens group.

In the variable magnification optical system of the present example, the front group includes the first lens group G1, the second lens group G2, and the third lens group G3. In the variable magnification optical system of the present example, the rear group includes the fourth lens group G4, the fifth lens group G5, and the sixth lens group G6.

In the variable magnification optical system of the present example, the lens surfaces in the final lens group having a pole are the surface on the image side of the negative meniscus lens L72 (26th surface) and the surface on the object side of the negative meniscus lens L73 (27th surface); the 26th and 27th surfaces are adjacent to each other with an air layer in between; and the 27th surface is closest to the image side. Of the negative meniscus lenses L72 and L73, which are lenses in the final lens group including a lens surface having a pole, the negative meniscus lens L73 is closest to the image side. The final lens is the negative meniscus lens L73.

Table 1 below shows specifications of the variable magnification optical system of the present example. In Table 1, fw denotes the focal length in the wide-angle end state, ft the focal length in the telephoto end state, FnoW the F-number in the wide-angle end state, FnoT the F-number in the telephoto end state, TL the shorter of the total optical length in the wide-angle end state and the total optical length in the telephoto end state, BFw the back focus in the wide-angle end state, and BFt the back focus in the telephoto end state.

In [Lens specifications], m denotes the positions of the optical surfaces counted from the object side, r the radii of curvature, d the surface-to-surface distances, nd the refractive indices for d-line (wavelength 587.6 nm), and vd the Abbe numbers for d-line. In [Lens specifications], the radius of curvature r=∞ means a plane. In [Lens specifications], the optical surfaces with “*” are aspherical surfaces.

In [Aspherical data], ASP denotes the optical surface corresponding to the aspherical data, K the conic constant, and A4 to A10 the spherical constants.

The aspherical surfaces are expressed by equation (a) below, where the height in the direction perpendicular to the optical axis is denoted by y, the distance along the optical axis from the tangent plane at the vertex of an aspherical surface to the aspherical surface at height y (a sag) by S(y), the radius of curvature of a reference sphere (paraxial radius of curvature) by r, the conic constant by K, and the n-th order aspherical coefficient by An. In the examples, the second order aspherical coefficient A2 is 0. “E-n” denotes “×10⁻ⁿ.”

S(y)=(y²/r)/{1+(1−K×y²/r²)/^{1/2}}+A4×y⁴+A6×y⁶+A8×y⁸+A10×y¹⁰+A12×y¹² (a)

The unit of the focal lengths f, the radii of curvature r, and the other lengths listed in Table 1 is “mm.” However, the unit is not limited thereto because the optical performance of a proportionally enlarged or reduced optical system is the same as that of the original optical system.

The above reference symbols in Table 1 will also be used similarly in the tables of the other examples described below.

TABLE 1
[General specifications]

| | |
|---|---|
| fw | 24.800 |
| ft | 67.899 |
| FnoW | 2.918 |
| FnoT | 2.919 |
| BFw | 11.754 |
| BFt | 20.313 |
| TL | 158.763 |

[Lens specifications]

| m | r | d | nd | νd |
|---|---|---|---|---|
| 1) | 216.2097 | 2.900 | 1.69343 | 53.30 |
| * 2) | 29.8289 | 14.391 | | |
| 3) | 307.5459 | 2.100 | 1.59349 | 67.00 |
| 4) | 36.0228 | 6.545 | 2.00100 | 29.12 |
| 5) | 73.1086 | D5 | | |
| 6) | 185.2739 | 6.802 | 1.81600 | 46.59 |
| 7) | −50.5827 | 1.500 | 1.90200 | 25.26 |
| 8) | −131.0353 | D8 | | |
| 9) | 39.0819 | 1.500 | 1.85000 | 27.03 |
| 10) | 25.5513 | 10.624 | 1.59319 | 67.90 |
| 11) | −146.6131 | D11 | | |
| 12) | ∞ | 2.189 | (Aperture stop) | |
| 13) | −78.2028 | 1.000 | 1.90265 | 35.73 |
| 14) | 44.8279 | 0.200 | | |
| 15) | 29.9936 | 2.451 | 1.48749 | 70.31 |
| 16) | 47.5101 | 0.246 | | |
| 17) | 40.9589 | 3.646 | 1.94595 | 17.98 |
| 18) | 141.2376 | D18 | | |
| 19) | 45.7656 | 7.200 | 1.48749 | 70.31 |
| 20) | −25.4158 | 1.300 | 1.73800 | 32.26 |
| 21) | −114.4359 | D21 | | |
| 22) | 960.5587 | 4.203 | 1.58887 | 61.13 |
| *23) | −50.4632 | D23 | | |
| 24) | −108.3950 | 6.899 | 1.81600 | 46.59 |
| 25) | −24.6078 | 1.500 | 1.81930 | 45.76 |
| *26) | −86.0097 | 5.884 | | |
| *27) | −30.0456 | 1.500 | 1.58887 | 61.13 |

| | | |
|---|---|---|
| 28) | −454.6183 | BFw/BFt |

[Aspherical data]
ASP: 2nd surface

| | | | | |
|---|---|---|---|---|
| K: | 0.0000 | | | |
| A4: | 2.47030E−06 | A6: | 1.29637E−09 | A8:−8.00742E−13 |
| A10: | 1.31247E−15 | A12: | −3.37400E−19 | |

ASP: 23rd surface

| | | | | |
|---|---|---|---|---|
| K: | 1.0000 | | | |
| A4: | 1.41469E−05 | A6: | −3.83973E−08 | A8: 1.80756E−10 |
| A10: | −1.29883E−13 | | | |

ASP: 26th surface

| | | | | |
|---|---|---|---|---|
| K: | 1.0000 | | | |
| A4: | 5.74243E−06 | A6: | 9.46155E−08 | A8: −7.42534E−11 |
| A10: | −2.32790E−13 | | | |

ASP: 27th surface

| | | | | |
|---|---|---|---|---|
| K: | 1.0000 | | | |
| A4: | 2.57159E−05 | A6: | 1.23215E−07 | A8: −2.69647E−10 |
| A10: | 1.45442E−13 | | | |

[Focal length data of groups]

| Groups | Starting surfaces | Focal lengths |
|---|---|---|
| f1 | 1 | −48.395 |
| f2 | 6 | 105.403 |
| f3 | 9 | 64.392 |
| f4 | 13 | −112.410 |
| f5 | 19 | 134.882 |
| f6 | 22 | 81.543 |
| f7 | 24 | −60.633 |

[Variable distance data]

| | W | M | T |
|---|---|---|---|
| D5 | 57.738 | 11.990 | 3.100 |
| D8 | 1.000 | 4.757 | 1.000 |
| D11 | 1.900 | 12.709 | 26.370 |
| D18 | 18.418 | 11.653 | 10.584 |
| D21 | 3.797 | 10.128 | 10.797 |
| D23 | 2.268 | 4.129 | 2.018 |

W: Wide-angle end state
M: Intermediate focal length
T: Telephoto end state

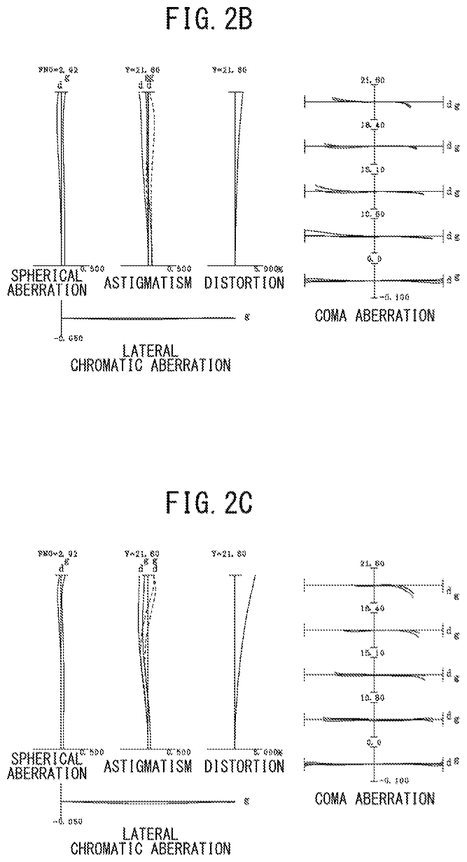

FIG. 2A illustrates aberrations of the variable magnification optical system of the first example in the wide-angle end state. FIG. 2B illustrates aberrations of the variable magnification optical system of the first example in an intermediate focal length state. FIG. 2C illustrates aberrations of the variable magnification optical system of the first example in the telephoto end state.

In the graphs of aberrations, FNO and Y denote F-number and image height, respectively. More specifically, the graph of spherical aberration shows the value of F-number corresponding to the maximum aperture, the graphs of astigmatism and distortion show the maximum of image height, and the graph of coma aberration shows the value of image height. d and g denote d-line and g-line (wavelength 435.8 nm), respectively. In the graph of astigmatism, the solid lines and the broken lines show a sagittal plane and a meridional plane, respectively. The reference symbols in the graphs of aberrations of the present example will also be used in those of the other examples described below.

The graphs of aberrations suggest that the variable magnification optical system of the present example effectively reduces variations in aberrations at focusing and has high optical performance.

### Second Example

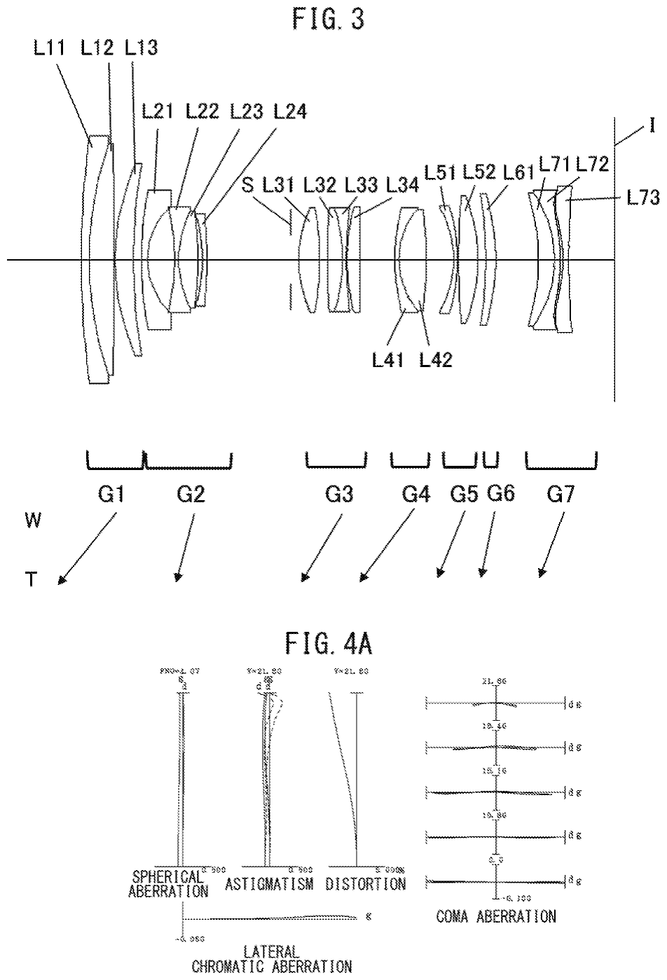

FIG. 3 is a cross-sectional view of a variable magnification optical system of a second example.

The variable magnification optical system of the present example includes a first lens group G1 having positive refractive power, a second lens group G2 having negative refractive power, a third lens group G3 having positive refractive power, a fourth lens group G4 having positive refractive power, a fifth lens group G5 having positive refractive power, a sixth lens group G6 having positive refractive power, and a seventh lens group G7 having negative refractive power, in order from an object side. The seventh lens group G7 is a final lens group closest to an image side of the lens groups. An aperture stop S is disposed between the second lens group G2 and the third lens group G3.

The first lens group G1 consists of a positive cemented lens composed of a negative meniscus lens L11 convex on the object side and a biconvex positive lens L12 as well as a positive meniscus lens L13 convex on the object side, in order from the object side.

The second lens group G2 consists of a negative meniscus lens L21 convex on the object side, a positive cemented lens composed of a biconcave negative lens L22 and a biconvex positive lens L23, and a negative meniscus lens L24 convex on the image side, in order from the object side.

The third lens group G3 consists of a biconvex positive lens L31, a negative cemented lens composed of a biconvex positive lens L32 and a biconcave negative lens L33, and a positive meniscus lens L34 convex on the object side, in order from the object side.

The fourth lens group G4 consists of a positive cemented lens composed of a negative meniscus lens L41 convex on the object side and a biconvex positive lens L42.

The fifth lens group G5 consists of a negative meniscus lens L51 convex on the image side and a biconvex positive lens 52, in order from the object side.

The sixth lens group G6 consists of a positive meniscus lens L61 convex on the image side.

The seventh lens group G7 consists of a positive cemented lens composed of a positive meniscus lens G71 convex on the image side and a negative meniscus lens G72 convex on the image side as well as a biconcave negative lens G73, in order from the object side.

On an image plane I is disposed an imaging device (not shown) constructed from CCD, CMOS or the like.

Upon varying magnification from a wide-angle end state to a telephoto end state, the lens groups in the variable magnification optical system of the present example having the above configuration move along the optical axis so that the distance between the first lens group G1 and the second lens group G2, the distance between the second lens group G2 and the third lens group G3, the distance between the third lens group G3 and the fourth lens group G4, the distance between the fourth lens group G4 and the fifth lens group G5, the distance between the fifth lens group G5 and the sixth lens group G6, and the distance between the sixth lens group G6 and the seventh lens group G7 are varied. More specifically, the first lens group G1, the second lens group G2, the third lens group G3, the fourth lens group G4, the fifth lens group G5, the sixth lens group G6, and the seventh lens group G7 move to the object side.

The variable magnification optical system of the present example focuses by moving the fifth lens group G5 and the sixth lens group G6 as focusing lens groups along the optical axis. The sixth lens group G6, which is one of the focusing lens groups, is adjacent to the seventh lens group G7, which is the final lens group.

In the variable magnification optical system of the present example, the front group includes the first lens group G1 and the second lens group G2. In the variable magnification optical system of the present example, the rear group includes the third lens group G3, the fourth lens group G4, the fifth lens group G5, and the sixth lens group G6.

In the variable magnification optical system of the present example, the lens surfaces in the final lens group having a pole are the surface on the image side of the negative meniscus lens L72 (32nd surface) and the surface on the object side of the negative lens L73 (33rd surface); the 32nd and 33rd surfaces are adjacent to each other with an air layer in between; and the 33rd surface is closest to the image side. Of the negative meniscus lens L72 and the negative lens L73, which are lenses in the final lens group including a lens surface having a pole, the negative lens L73 is closest to the image side. The final lens is the negative lens L73.

Table 2 below shows specifications of the variable magnification optical system of the present example.

TABLE 2
[General specifications]

| | |
|---|---|
| fw | 24.700 |
| ft | 117.000 |
| FnoW | 4.063 |
| FnoT | 4.066 |
| BFw | 11.455 |
| BFt | 38.827 |
| TL | 134.455 |

[Lens specifications]

| m | r | d | nd | νd |
|---|---|---|---|---|
| 1) | 233.5776 | 2.000 | 1.85000 | 27.03 |
| 2) | 87.6482 | 6.431 | 1.59319 | 67.90 |
| 3) | −959.0443 | 0.200 | | |
| 4) | 60.1618 | 4.651 | 1.77250 | 49.62 |
| 5) | 146.6456 | D5 | | |
| * 6) | 117.5696 | 1.500 | 1.82098 | 42.50 |
| 7) | 18.3423 | 6.793 | | |
| 8) | −54.1107 | 1.000 | 1.59319 | 67.90 |
| 9) | 25.8545 | 4.820 | 1.85000 | 27.03 |
| 10) | −104.7590 | 1.300 | | |
| 11) | −35.7972 | 1.000 | 1.77250 | 49.62 |
| 12) | −130.0576 | D12 | | |
| 13) | ∞ | 2.000 | (Aperture stop) | |
| *14) | 29.2194 | 5.294 | 1.55332 | 71.68 |
| 15) | −70.1452 | 1.936 | | |
| 16) | 191.4975 | 3.770 | 1.49782 | 82.57 |
| 17) | −43.7144 | 1.000 | 1.95000 | 29.37 |
| 18) | 100.0764 | 0.200 | | |
| 19) | 52.3316 | 3.117 | 1.89286 | 20.36 |
| 20) | 2501.4801 | D20 | | |
| 21) | 52.8575 | 1.000 | 1.88898 | 30.72 |
| 22) | 19.7421 | 6.865 | 1.59319 | 67.90 |
| 23) | −108.3585 | D23 | | |
| 24) | −26.4757 | 1.000 | 1.97639 | 21.60 |
| 25) | −41.4541 | 0.200 | | |
| 26) | 178.6947 | 4.819 | 1.76043 | 37.84 |
| 27) | −45.8627 | D27 | | |
| 28) | −106.6816 | 2.571 | 1.81600 | 46.59 |
| *29) | −46.0714 | D29 | | |
| 30) | −54.9936 | 4.015 | 1.79979 | 21.02 |
| 31) | −29.3478 | 1.500 | 1.81600 | 46.59 |
| *32) | −45.2224 | 0.638 | | |
| *33) | −36.3222 | 1.500 | 1.81951 | 45.71 |
| 34) | 228.7540 | BFw/BFt | | |

[Aspherical data]
ASP: 6th surface

| | | | | | |
|---|---|---|---|---|---|
| K: | 1.0000 | | | | |
| A4: | 5.41835E−06 | A6: | −1.00509E−08 | A8: | 1.79459E−11 |
| A10: | −1.19492E−14 | | | | |

ASP: 14th surface

| | | | | | |
|---|---|---|---|---|---|
| K: | 1.0000 | | | | |
| A4: | −8.73105E−06 | A6: | 9.15653E−09 | A8: | −3.61397E−11 |
| A10: | 7.79894E−14 | | | | |

ASP: 29th surface

| | | | | | |
|---|---|---|---|---|---|
| K: | 1.0000 | | | | |
| A4: | 1.09444E−05 | A6: | −5.46104E−09 | A8: | 7.47476E−12 |
| A10: | 1.54099E−14 | | | | |

ASP: 32nd surface

| | | | | | |
|---|---|---|---|---|---|
| K: | 1.0000 | | | | |
| A4: | −2.47778E−06 | A6: | 4.98007E−08 | A8: | 4.30324E−10 |
| A10: | −8.73793E−13 | | | | |

ASP: 33rd surface

| | | | | | |
|---|---|---|---|---|---|
| K: | 1.0000 | | | | |
| A4: | 3.23230E−06 | A6: | 5.85216E−08 | A8: | 3.47364E−10 |
| A10: | −7.19137E−13 | | | | |

[Focal length data of groups]

| Groups | Starting surfaces | Focal lengths |
|---|---|---|
| f1 | 1 | 110.518 |
| f2 | 6 | −20.307 |
| f3 | 14 | 38.507 |
| f4 | 21 | 136.085 |
| f5 | 24 | 113.890 |
| f6 | 28 | 97.518 |
| f7 | 30 | −42.419 |

[Variable distance data]

| | W | M | T |
|---|---|---|---|
| D5 | 2.000 | 28.786 | 42.092 |
| D12 | 21.164 | 5.661 | 2.000 |
| D20 | 8.937 | 4.555 | 2.000 |
| D23 | 6.958 | 12.760 | 21.599 |
| D27 | 2.000 | 10.310 | 9.817 |
| D29 | 10.821 | 5.716 | 2.000 |

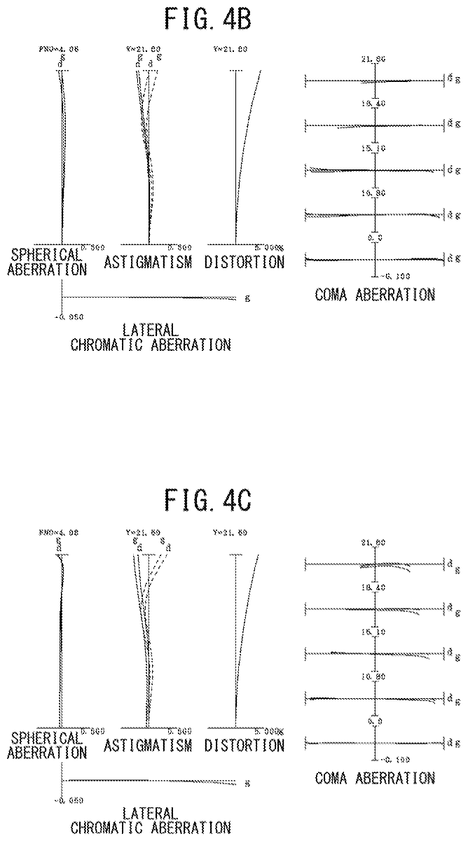

FIG. 4A illustrates aberrations of the variable magnification optical system of the second example in the wide-angle end state. FIG. 4B illustrates aberrations of the variable magnification optical system of the second example in an intermediate focal length state. FIG. 4C illustrates aberrations of the variable magnification optical system of the second example in the telephoto end state.

The graphs of aberrations suggest that the variable magnification optical system of the present example effectively reduces variations in aberrations at focusing and has high optical performance.

### Third Example

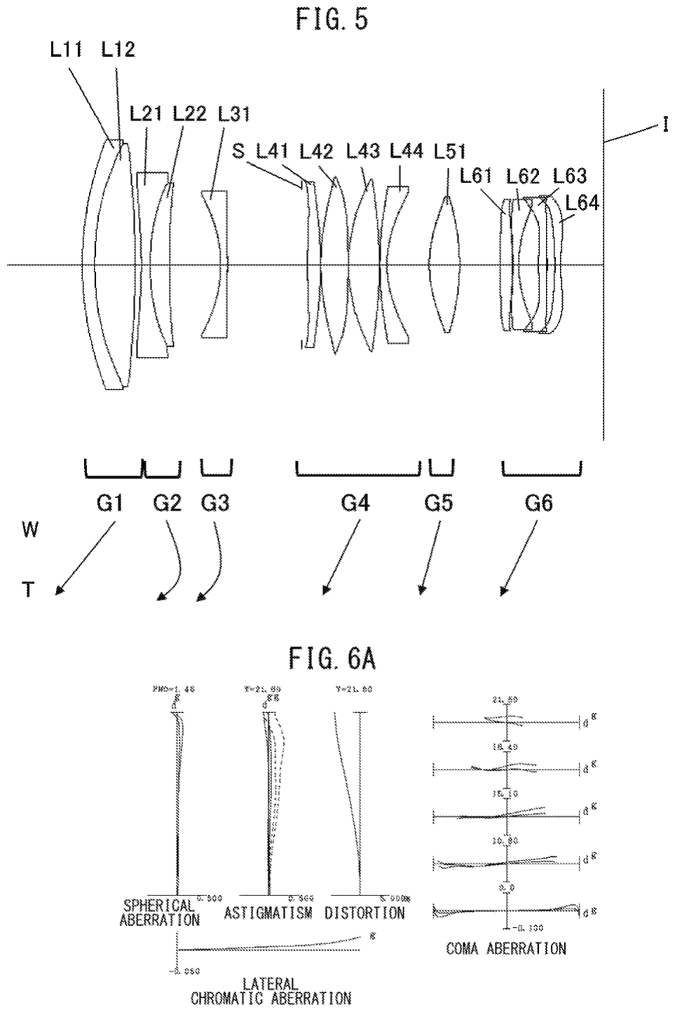

FIG. 5 is a cross-sectional view of a variable magnification optical system of a third example.

The variable magnification optical system of the present example includes a first lens group G1 having positive refractive power, a second lens group G2 having negative refractive power, a third lens group G3 having negative refractive power, a fourth lens group G4 having positive refractive power, a fifth lens group G5 having positive refractive power, and a sixth lens group G6 having negative refractive power, in order from an object side. The sixth lens group G6 is a final lens group closest to an image side of the lens groups. An aperture stop S is disposed between the third lens group G3 and the fourth lens group G4.

The first lens group G1 consists of a positive cemented lens composed of a negative meniscus lens L11 convex on the object side and a biconvex positive lens L12, in order from the object side.

The second lens group G2 consists of a negative cemented lens composed of a biconcave negative lens L21 and a positive meniscus lens L22 convex on the object side, in order from the object side.

The third lens group G3 consists of a negative meniscus lens L31 convex on the image side.

The fourth lens group G4 consists of a biconvex positive lens L41, a biconvex positive lens L42, a biconvex positive lens L43, and a negative meniscus lens L44 convex on the object side, in order from the object side.

The fifth lens group G5 consists of a biconvex positive lens L51.

The sixth lens group G6 consists of a biconvex positive lens L61, a biconcave negative lens L62, a biconvex positive lens L63, and a biconcave negative lens L64, in order from the object side.

On an image plane I is disposed an imaging device (not shown) constructed from CCD, CMOS or the like.

Upon varying magnification from a wide-angle end state to a telephoto end state, the lens groups in the variable magnification optical system of the present example having the above configuration move along the optical axis so that the distance between the first lens group G1 and the second lens group G2, the distance between the second lens group G2 and the third lens group G3, the distance between the third lens group G3 and the fourth lens group G4, the distance between the fourth lens group G4 and the fifth lens group G5, and the distance between the fifth lens group G5 and the sixth lens group G6 are varied. More specifically, the second lens group G2 and the third lens group G3 move to the image side temporarily and then to the object side. The first lens group G1, the fourth lens group G4, the fifth lens group G5, and the sixth lens group G6 move to the object side.

The variable magnification optical system of the present example focuses by moving the third lens group G3 and the fifth lens group G5 as focusing lens groups along the optical axis. The fifth lens group G5, which is one of the focusing lens groups, is adjacent to the sixth lens group G6, which is the final lens group.

In the variable magnification optical system of the present example, the front group includes the first lens group G1, the second lens group G2, and the third lens group G3. In the variable magnification optical system of the present example, the rear group includes the fourth lens group G4 and the fifth lens group G5.

In the variable magnification optical system of the present example, the lens surfaces in the final lens group having a pole are the surface on the image side of the positive lens L61 (21st surface), the surface on the object side of the negative lens L62 (22nd surface), the surfaces on the object side and on the image side of the positive lens L63 (24th and 25th surfaces), and the surface on the image side of the negative lens L64 (27th surface); the 21st and 22nd surfaces are adjacent to each other with an air layer in between; and the 27th surface is closest to the image side. Of the positive lens L61, the negative lens L62, the positive lens L63, and the negative lens L64, which are lenses in the final lens group including a lens surface having a pole, the negative lens L64 is closest to the image side. The final lens is the negative lens L64.

Table 3 below shows specifications of the variable magnification optical system of the present example.

TABLE 3
[General specifications]

| | |
|---|---|
| fw | 41.218 |
| ft | 130.898 |
| FnoW | 1.460 |
| FnoT | 2.428 |
| BFw | 10.671 |
| BFt | 37.896 |
| TL | 129.421 |

[Lens specifications]

| m | r | d | nd | νd |
|---|---|---|---|---|
| * 1) | 82.8316 | 3.000 | 1.89286 | 20.36 |
| 2) | 66.9706 | 10.222 | 1.49782 | 82.57 |
| 3) | −242.7859 | D3 | | |
| * 4) | −120.1511 | 2.201 | 1.88300 | 40.69 |
| * 5) | 57.2914 | 4.785 | 1.92286 | 18.90 |
| * 6) | 354.5248 | D6 | | |
| * 7) | −32.5395 | 1.630 | 1.58913 | 61.22 |
| * 8) | −422.5439 | D8 | | |
| 9) | ∞ | 1.500 | (Aperture stop) | |
| *10) | 159.3869 | 3.156 | 1.88300 | 40.69 |
| 11) | −126.7940 | 0.100 | | |
| *12) | 57.8313 | 6.782 | 1.49782 | 82.57 |
| *13) | −264.4384 | 0.100 | | |
| 14) | 43.8755 | 7.657 | 1.49782 | 82.57 |
| *15) | −102.4023 | 0.100 | | |
| *16) | 93.9056 | 1.777 | 1.96300 | 24.11 |
| *17) | 27.7244 | D17 | | |
| *18) | 30.0338 | 7.496 | 1.49782 | 82.57 |
| *19) | −52.3192 | D19 | | |
| *20) | 463.2651 | 3.006 | 1.92286 | 18.90 |
| *21) | −95.3639 | 0.122 | | |
| *22) | −72.1888 | 1.433 | 1.58913 | 61.22 |
| *23) | 30.1205 | 4.982 | | |
| *24) | 49.5222 | 2.134 | 1.69350 | 53.20 |
| *25) | −206.0064 | 1.873 | | |
| *26) | −82.7023 | 1.500 | 1.74320 | 49.26 |
| *27) | 42.0814 | BFw/BFt | | |

[Aspherical data]
ASP: 1st surface

| | | | | | |
|---|---|---|---|---|---|
| K: | 1.0000 | | | | |
| A4: | −2.76888E−08 | A6: | −1.42190E−11 | A8: | −1.51976E−15 |
| A10: | 0.00000E+00 | | | | |

ASP: 4th surface

| | | | | | |
|---|---|---|---|---|---|
| K: | 1.0000 | | | | |
| A4 : | 5.16437E−06 A6: | A6: | −2.54235E−09 | A8: | 9.97190E−14 |
| A10: | 0.00000E+00 | | | | |

ASP: 5th surface

| | | | | | |
|---|---|---|---|---|---|
| K: | 1.0000 | | | | |
| A4: | 2.30703E−06 | A6: | 3.96346E−09 | A8: | −4.51403E−12 |
| A10: | 0.00000E+00 | | | | |

ASP: 6th surface

| | | | | | |
|---|---|---|---|---|---|
| K: | 1.0000 | | | | |
| A4: | 3.56773E−06 | A6: | −1.13793E−09 | A8: | −3.26259E−12 |
| A10: | 0.00000E+00 | | | | |

ASP: 7th surface

| | | | | | |
|---|---|---|---|---|---|
| K: | 1.0000 | | | | |
| A4: | 1.46926E−06 | A6: | −5.54330E−11 | A8: | 1.86600E−11 |
| A10: | 0.00000E+00 | | | | |

ASP: 8th surface

| | | | | | |
|---|---|---|---|---|---|
| K: | 1.0000 | | | | |
| A4: | 2.27322E−06 | A6: | −1.96168E−09 | A8: | 1.33973E−11 |
| A10: | 0.00000E+00 | | | | |

ASP: 10th surface

| | | | | | |
|---|---|---|---|---|---|
| K: | 1.0000 | | | | |
| A4: | −8.46912E−06 | A6: | 6.18341E−10 | A8: | −1.20691E−11 |
| A10: | 0.00000E+00 | | | | |

ASP: 12th surface

| | | | | | |
|---|---|---|---|---|---|
| K: | 1.0000 | | | | |
| A4: | −3.35954E−06 | A6: | −3.14246E−09 | A8: | 5.51747E−12 |
| A10: | 0.00000E+00 | | | | |

ASP: 13th surface

| | | | | | |
|---|---|---|---|---|---|
| K: | 1.0000 | | | | |
| A4: | −6.60389E−06 | A6: | −1.04867E−08 | A8: | 7.80931E−12 |
| A10: | 0.00000E+00 | | | | |

ASP: 15th surface

| | | | | | |
|---|---|---|---|---|---|
| K: | 1.0000 | | | | |
| A4: | 3.86065E−06 | A6: | −7.71540E−09 | A8: | 9.20129E−12 |
| A10: | 0.00000E+00 | | | | |

ASP: 16th surface

| | | | | | |
|---|---|---|---|---|---|
| K: | 1.0000 | | | | |
| A4: | 3.32157−E06 | A6: | −1.40119E−08 | A8: | 1.36738E−11 |
| A10: | 0.00000E+00 | | | | |

ASP: 17th surface

| | | | | | |
|---|---|---|---|---|---|
| K: | 1.0000 | | | | |
| A4: | −9.75720E−06 | A6: | −3.36474E−09 | A8: | −1.21055E−11 |
| A10: | 0.00000E+00 | | | | |

ASP: 18th surface

| | | | | | |
|---|---|---|---|---|---|
| K: | 1.0000 | | | | |
| A4: | −1.44803E−05 | A6: | 8.84782E−10 | A8: | −1.49170E−11 |
| A10: | 0.00000E+00 | | | | |

ASP: 19th surface

| | | | | | |
|---|---|---|---|---|---|
| K: | 1.0000 | | | | |
| A4: | 3.80299E−06 | A6: | −4.89754E−09 | A8: | 4.99904E−12 |
| A10: | 0.00000E+00 | | | | |

ASP: 20th surface

| | | | | | |
|---|---|---|---|---|---|
| K: | 1.0000 | | | | |
| A4: | 2.80494E−06 | A6: | −1.96075E−08 | A8: | 1.74481E−10 |
| A10: | 0.00000E+00 | | | | |

ASP: 21st surface

| | | | | | |
|---|---|---|---|---|---|
| K: | 1.0000 | | | | |
| A4: | 4.06798E−06 | A6: | 6.38920E−09 | A8: | 9.23842E−11 |
| A10: | 0.00000E+00 | | | | |

ASP: 22nd surface

| | | | | | |
|---|---|---|---|---|---|
| K: | 1.0000 | | | | |
| A4: | 4.10047E−05 | A6: | −6.58416E−08 | A8: | 5.69369E−11 |
| A10: | 0.00000E+00 | | | | |

ASP: 23rd surface

| | | | | | |
|---|---|---|---|---|---|
| K: | 1.0000 | | | | |
| A4: | −5.63912E−06 | A6: | 3.45717E−08 | A8: | −2.88915E−10 |
| A10: | 0.00000E+00 | | | | |

ASP: 24th surface

| | | | | | |
|---|---|---|---|---|---|
| K: | 1.0000 | | | | |
| A4: | −9.53059E−05 | A6: | −2.05939E−07 | A8: | 8.35742E−10 |
| A10: | 0.00000E+00 | | | | |

ASP: 25th surface

| | | | | | |
|---|---|---|---|---|---|
| K: | 1.0000 | | | | |
| A4: | 2.41063E−05 | A6: | −1.80146E−07 | A8: | 4.31393E−10 |
| A10: | 0.00000E+00 | | | | |

ASP: 26th surface

| | | | | | |
|---|---|---|---|---|---|
| K: | 1.0000 | | | | |
| A4: | 7.16008E−06 | A6: | 6.38334E−08 | A8: | −6.89847E−10 |
| A10: | 0.00000E+00 | | | | |

ASP: 27th surface

| | | | | | |
|---|---|---|---|---|---|
| K: | 1.0000 | | | | |
| A4: | −9.05858E−05 | A6: | 1.89181E−07 | A8: | −4.52460E−10 |
| A10: | 0.00000E+00 | | | | |

[Focal length data of groups]

| Groups | Starting surfaces | Focal |
|---|---|---|
| f1 | 1 | 144.363 |
| f2 | 4 | −107.344 |
| f3 | 7 | −59.934 |
| f4 | 10 | 49.980 |
| f5 | 18 | 39.524 |
| f6 | 20 | −38.717 |

[Variable distance data]

| | W | M | T |
|---|---|---|---|
| D3 | 1.500 | 34.626 | 45.000 |
| D6 | 12.713 | 10.569 | 9.851 |
| D8 | 18.403 | 7.028 | 1.500 |
| D17 | 10.486 | 11.358 | 13.197 |
| D19 | 10.093 | 5.814 | 1.500 |

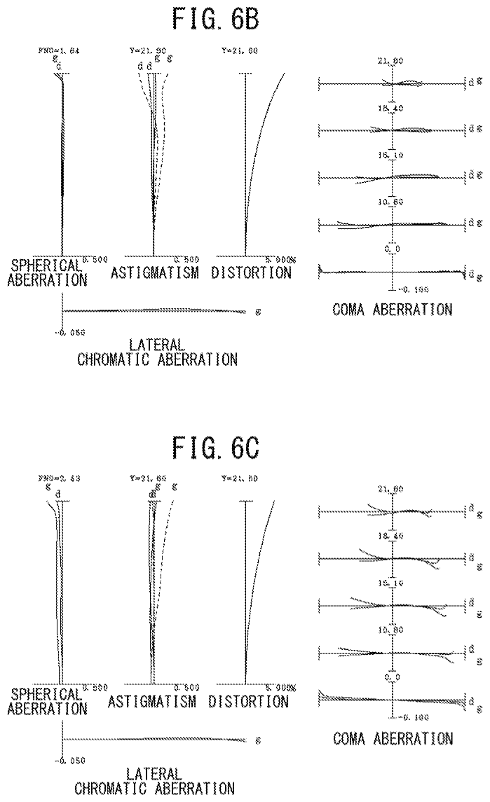

FIG. 6A illustrates aberrations of the variable magnification optical system of the third example in the wide-angle end state. FIG. 6B illustrates aberrations of the variable magnification optical system of the third example in an intermediate focal length state. FIG. 6C illustrates aberrations of the variable magnification optical system of the third example in the telephoto end state.

The graphs of aberrations suggest that the variable magnification optical system of the present example effectively reduces variations in aberrations at focusing and has high optical performance.

### Fourth Example

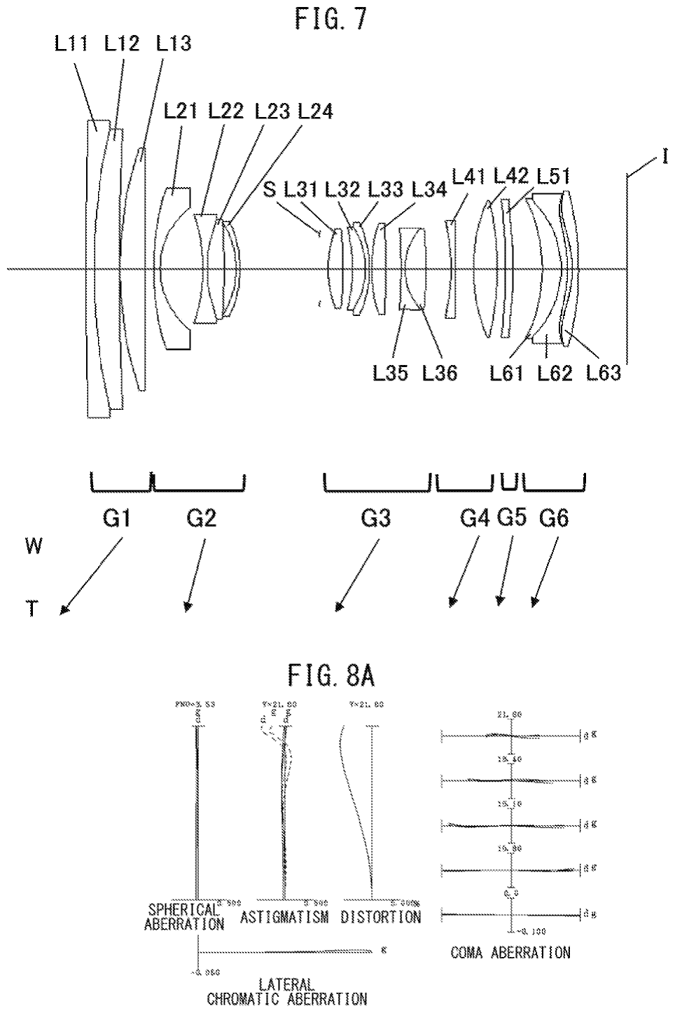

FIG. 7 is a cross-sectional view of a variable magnification optical system of a fourth example.

The variable magnification optical system of the present example includes a first lens group G1 having positive refractive power, a second lens group G2 having negative refractive power, a third lens group G3 having positive refractive power, a fourth lens group G4 having positive refractive power, a fifth lens group G5 having positive refractive power, and a sixth lens group G6 having negative refractive power, in order from an object side. The sixth lens group G6 is a final lens group closest to an image side of the lens groups. An aperture stop S is disposed between the second lens group G2 and the third lens group G3.

The first lens group G1 consists of a negative cemented lens composed of a negative meniscus lens L11 convex on the object side and a positive meniscus lens L12 convex on the object side as well as a biconvex positive lens L13, in order from the object side.

The second lens group G2 consists of a negative meniscus lens L21 convex on the object side, a negative cemented lens composed of a biconcave negative lens L22 and a biconvex positive lens L23, and a negative meniscus lens L24 convex on the image side, in order from the object side.

The third lens group G3 consists of a biconvex positive lens L31, a negative cemented lens composed of a positive meniscus lens L32 convex on the image side and a negative meniscus lens L33 convex on the image side, a biconvex positive lens L34, and a negative cemented lens composed of a biconcave negative lens L35 and a biconvex positive lens L36, in order from the object side.

The fourth lens group G4 consists of a biconcave negative lens L41 and a biconvex positive lens L42, in order from the object side.

The fifth lens group G5 consists of a positive meniscus lens L51 convex on the image side.

The sixth lens group G6 consists of a positive cemented lens composed of a positive meniscus lens L61 convex on the image side and a negative meniscus lens L62 convex on the image side as well as a negative meniscus lens L63 convex on the image side, in order from the object side.

On an image plane I is disposed an imaging device (not shown) constructed from CCD, CMOS or the like.

Upon varying magnification from a wide-angle end state to a telephoto end state, the lens groups in the variable magnification optical system of the present example having the above configuration move along the optical axis so that the distance between the first lens group G1 and the second lens group G2, the distance between the second lens group G2 and the third lens group G3, the distance between the third lens group G3 and the fourth lens group G4, the distance between the fourth lens group G4 and the fifth lens group G5, and the distance between the fifth lens group G5 and the sixth lens group G6 are varied. More specifically, the first lens group G1, the second lens group G2, the third lens group G3, the fourth lens group G4, the fifth lens group G5, and the sixth lens group G6 move to the object side.

The variable magnification optical system of the present example focuses by moving the fourth lens group G4 and the fifth lens group G5 as focusing lens groups along the optical axis. The fifth lens group G5, which is one of the focusing lens groups, is adjacent to the sixth lens group G6, which is the final lens group.

In the variable magnification optical system of the present example, the front group includes the first lens group G1 and the second lens group G2. In the variable magnification optical system of the present example, the rear group includes the third lens group G3, the fourth lens group G4, and the fifth lens group G5.

In the variable magnification optical system of the present example, the lens surfaces in the final lens group having a pole are the surface on the image side of the negative meniscus lens L62 (32nd surface) and the surface on the object side of the negative meniscus lens L63 (33rd surface); the 32nd and 33rd surfaces are adjacent to each other with an air layer in between; and the 33rd surface is closest to the image side. Of the negative meniscus lenses L62 and L63, which are lenses in the final lens group including a lens surface having a pole, the negative meniscus lens L63 is closest to the image side. The final lens is the negative meniscus lens L63.

Table 4 below shows specifications of the variable magnification optical system of the present example.

TABLE 4
[General specifications]

| | |
|---|---|
| fw | 24.700 |
| ft | 67.900 |
| FnoW | 3.534 |
| FnoT | 5.704 |
| BFw | 11.454 |
| BFt | 37.762 |
| TL | 128.454 |

[Lens specifications]

| | m | rd | nd | νd |
|---|---|---|---|---|
| 1) | 1117.9689 | 2.000 | 1.85000 | 27.03 |
| 2) | 151.6754 | 6.000 | 1.59319 | 67.90 |
| 3) | 604.3570 | 0.200 | | |
| 4) | 95.1148 | 6.000 | 1.80400 | 46.60 |
| 5) | −3888.8614 | D5 | | |
| * 6) | 77.0311 | 1.500 | 1.82098 | 42.50 |
| 7) | 18.3277 | 10.191 | | |
| 8) | −39.8674 | 1.000 | 1.59319 | 67.90 |
| 9) | 32.2316 | 3.964 | 1.85000 | 27.03 |
| 10) | −160.4566 | 2.810 | | |
| 11) | −20.7240 | 1.000 | 1.77250 | 49.62 |
| 12) | −26.4134 | D12 | | |
| 13) | ∞ | 2.000 | (Aperture stop) | 2.000 |
| *14) | 25.9174 | 3.517 | 1.55332 | 71.68 |
| 15) | −106.0252 | 2.266 | | |
| 16) | −37.8522 | 3.006 | 1.49782 | 82.57 |
| 17) | −18.6967 | 1.000 | 1.95000 | 29.37 |
| 18) | −26.7934 | 0.553 | | |
| 19) | 35.6642 | 3.342 | 1.89286 | 20.36 |
| 20) | −191.1865 | 3.584 | | |
| 21) | −146.6275 | 1.000 | 1.92643 | 24.50 |
| 22) | 14.7466 | 4.904 | 1.59319 | 67.90 |
| 23) | −120.3128 | D23 | | |
| 24) | −51.116 | 51.000 | 1.98283 | 26.42 |
| 25) | 737.3403 | 4.356 | | |
| 26) | 42.3632 | 5.569 | 1.72907 | 37.37 |
| 27) | −71.7670 | D27 | | |
| 28) | −133.5324 | 1.826 | 1.81932 | 45.76 |
| *29) | −70.5109 | D29 | | |
| 30) | −36.9754 | 4.433 | 1.83984 | 19.98 |
| 31) | −22.5369 | 1.500 | 1.86211 | 37.55 |
| *32) | −32.1387 | 1.139 | | |
| *33) | −25.0000 | 1.500 | 1.83552 | 42.13 |
| 34) | −73.1491 | BFw/BFt | | |

[Aspherical data]
ASP: 6th surface

| | | | | | |
|---|---|---|---|---|---|
| K: | 1.0000 | | | | |
| A4: | 4.42790E−06 | A6: | −4.84239E−10 | A8: | −9.10319E−12 |
| A10: | 3.51555E−14 | | | | |

ASP: 14th surface

| | | | | | |
|---|---|---|---|---|---|
| K: | 1.0000 | | | | |
| A4 : | −7.97690E−06 | A6: | −4.21779E−09 | A8: | 1.20186E−10 |
| A10: | −6.81333E−13 | | | | |

ASP: 29th surface

| | | | | | |
|---|---|---|---|---|---|
| K: | 1.0000 | | | | |
| A4 : | 1.49515E−05 | A6: | −1.13726E−08 | A8: | 4.96744E−11 |
| A10: | −1.20573E−13 | | | | |

ASP: 32nd surface

| | | | | | |
|---|---|---|---|---|---|
| K: | 1.0000 | | | | |
| A4: | 1.46066E−05 | A6: | 7.69919E−08 | A8: | 3.39086E−10 |
| A10: | −9.94878E−13 | | | | |

ASP: 33rd surface

| | | | | | |
|---|---|---|---|---|---|
| K: | 1.0000 | | | | |
| A4: | 2.64437E−05 | A6: | 7.82319E−08 | A8: | 2.81284E−10 |
| A10: | −8.35503E−13 | | | | |

[Focal length data of groups]

| Groups | Starting surfaces | Focal lengths |
|---|---|---|
| f1 | 1 | 147.795 |
| f2 | 6 | −21.765 |
| f3 | 14 | 28.551 |
| f4 | 21 | 104.520 |
| f5 | 24 | 180.000 |
| f6 | 28 | −55.064 |

[Variable distance data]

| | W | M | T |
|---|---|---|---|
| D5 | 2.000 | 17.953 | 24.917 |
| D12 | 18.868 | 5.788 | 2.000 |
| D24 | 5.964 | 8.699 | 10.664 |
| D28 | 2.000 | 4.108 | 5.039 |
| D30 | 7.009 | 4.668 | 3.540 |

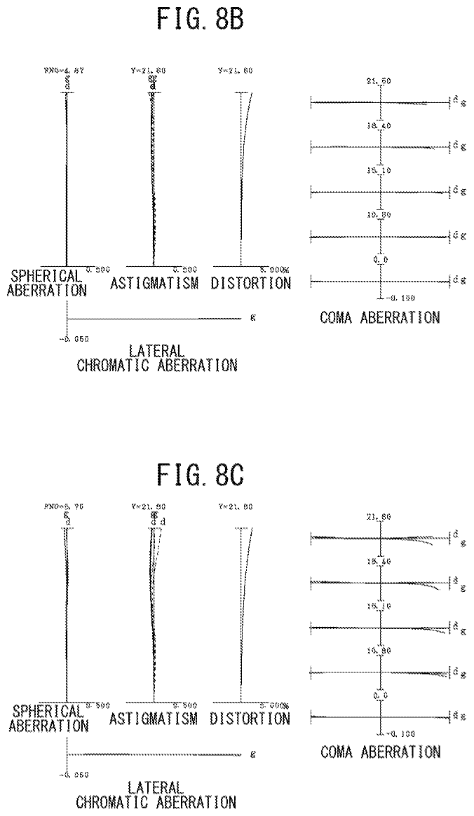

FIG. 8A illustrates aberrations of the variable magnification optical system of the fourth example in the wide-angle end state. FIG. 8B illustrates aberrations of the variable magnification optical system of the fourth example in an intermediate focal length state. FIG. 8C illustrates aberrations of the variable magnification optical system of the fourth example in the telephoto end state.

The graphs of aberrations suggest that the variable magnification optical system of the present example effectively reduces variations in aberrations at focusing and has high optical performance.

### Fifth Example

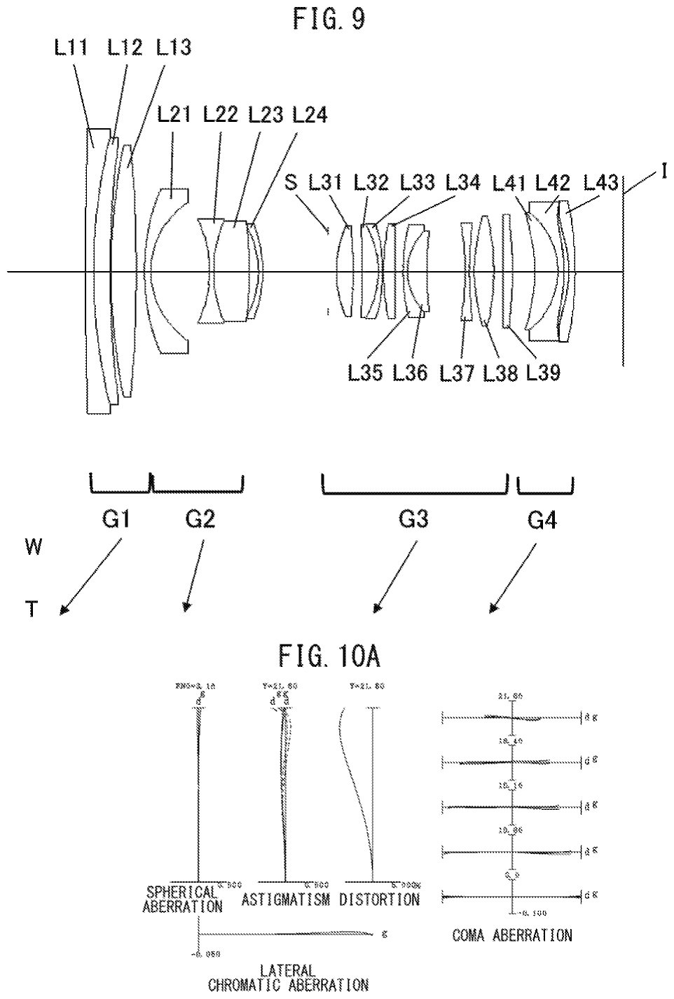

FIG. 9 is a cross-sectional view of a variable magnification optical system of a fifth example.

The variable magnification optical system of the present example includes a first lens group G1 having positive refractive power, a second lens group G2 having negative refractive power, a third lens group G3 having positive refractive power, and a fourth lens group G4 having negative refractive power, in order from an object side. The fourth lens group G4 is a final lens group closest to an image side of the lens groups. An aperture stop S is disposed between the second lens group G2 and the third lens group G3.

The first lens group G1 consists of a negative cemented lens composed of a negative meniscus lens L11 convex on the object side and a positive meniscus lens L12 convex on the object side as well as a biconvex positive lens L13, in order from the object side.

The second lens group G2 consists of a negative meniscus lens L21 convex on the object side, a negative cemented lens composed of a biconcave negative lens L22 and a biconvex positive lens L23, and a negative meniscus lens L24 convex on the image side, in order from the object side.

The third lens group G3 consists of a biconvex positive lens L31, a positive cemented lens composed of a positive meniscus lens L32 convex on the image side and a negative meniscus lens L33 convex on the image side, a biconvex positive lens L34, a negative cemented lens composed of a negative meniscus lens L35 convex on the object side and a positive meniscus lens L36 convex on the object side, a biconcave negative lens L37, a biconvex positive lens L38, and a positive meniscus lens L39 convex on the image side, in order from the object side.

The fourth lens group G4 consists of a positive cemented lens composed of a positive meniscus lens L41 convex on the image side and a negative meniscus lens L42 convex on the image side as well as a negative meniscus lens L43 convex on the image side, in order from the object side.

On an image plane I is disposed an imaging device (not shown) constructed from CCD, CMOS or the like.

Upon varying magnification from a wide-angle end state to a telephoto end state, the lens groups in the variable magnification optical system of the present example having the above configuration move along the optical axis so that the distance between the first lens group G1 and the second lens group G2, the distance between the second lens group G2 and the third lens group G3, and the distance between the third lens group G3 and the fourth lens group G4 are varied. More specifically, the first lens group G1, the second lens group G2, the third lens group G3, and the fourth lens group G4 move to the object side.

The variable magnification optical system of the present example focuses by moving the negative lens L37, the positive lens L38, and the positive meniscus lens L39 in the third lens group G3 along the optical axis.

In the variable magnification optical system of the present example, the front group includes the first lens group G1 and the second lens group G2. In the variable magnification optical system of the present example, the rear group includes the third lens group G3.

In the variable magnification optical system of the present example, the lens surfaces in the final lens group having a pole are the surface on the image side of the negative meniscus lens L42 (32nd surface) and the surface on the object side of the negative meniscus lens L43 (33rd surface); the 32nd and 33rd surfaces are adjacent to each other with an air layer in between; and the 33rd surface is closest to the image side. Of the negative meniscus lenses L42 and L43, which are lenses in the final lens group including a lens surface having a pole, the negative meniscus lens L43 is closest to the image side. The final lens is the negative meniscus lens L43.

Table 5 below shows specifications of the variable magnification optical system of the present example.

TABLE 5
[General specifications]

| | |
|---|---|
| fw | 24.699 |
| ft | 67.894 |
| FnoW | 3.183 |
| FnoT | 5.856 |
| BFw | 11.452 |
| BFt | 45.888 |
| TL | 128.452 |

[Lens specifications]

| m | r | d | nd | νd |
|---|---|---|---|---|
| 1) | 1079.5916 | 2.000 | 1.85000 | 27.03 |
| 2) | 131.0401 | 4.000 | 1.59319 | 67.90 |
| 3) | 250.0000 | 0.200 | | |
| 4) | 150.0000 | 6.006 | 1.80400 | 46.60 |
| 5) | −348.2905 | D5 | | |
| * 6) | 58.0611 | 1.500 | 1.82098 | 42.50 |
| 7) | 19.6123 | 14.025 | | |
| 8) | −29.0748 | 1.000 | 1.59319 | 67.90 |
| 9) | 31.5055 | 8.443 | 1.85000 | 27.03 |
| 10) | −106.9081 | 2.211 | | |
| 11) | −22.1747 | 1.000 | 1.77250 | 49.62 |
| 12) | −31.3884 | D12 | | |
| 13) | ∞ | 2.000 | (Aperture stop) | |
| *14) | 25.4805 | 4.020 | 1.55332 | 71.68 |
| 15) | −113.5173 | 2.153 | | |
| 16) | −239.9198 | 3.891 | 1.49782 | 82.57 |
| 17) | −22.1721 | 1.000 | 1.95000 | 29.37 |
| 18) | −39.0858 | 0.200 | | |
| 19) | 52.2652 | 2.726 | 1.89286 | 20.36 |
| 20) | −1068.6197 | 2.000 | | |
| 21) | 49.5620 | 1.000 | 1.84986 | 29.09 |
| 22) | 13.5449 | 4.613 | 1.59319 | 67.90 |
| 23) | 75.8355 | 9.162 | | |
| 24) | −64.9984 | 1.000 | 1.98765 | 23.25 |
| 25) | 98.0551 | 1.159 | | |
| 26) | 42.6108 | 4.661 | 1.66696 | 26.88 |
| 27) | −59.111 | 62.260 | | |
| 28) | −676.8447 | 2.263 | 1.48749 | 70.32 |
| *29) | −62.6788 | D29 | | |
| 30) | −42.7013 | 5.543 | 1.70633 | 24.58 |
| 31) | −17.9430 | 1.500 | 1.89105 | 33.79 |
| *32) | −34.7690 | 1.119 | | |
| *33) | −26.5315 | 1.500 | 1.88300 | 40.69 |
| 34) | −82.1646 | BFw/BFt | | |

[Aspherical data]
ASP: 6th surface

| | | | | | |
|---|---|---|---|---|---|
| K: | 1.0000 | | | | |
| A4: | 3.37459E−06 | A6: | −1.04691E−09 | A8: | 1.98567E−12 |
| A10: | 6.24320E−15 | | | | |

ASP: 14th surface

| | | | | | |
|---|---|---|---|---|---|
| K: | 1.0000 | | | | |
| A4: | −1.13875E−05 | A6: | 4.02722E−09 | A8: | 9.68479E−12 |
| A10: | −6.13774E−14 | | | | |

ASP: 29th surface

| | | | | | |
|---|---|---|---|---|---|
| K: | 1.0000 | | | | |
| A4: | 2.17948E−05 | A6: | −1.90983E−08 | A8: | 1.44726E−10 |
| A10: | −5.65784E−13 | | | | |

ASP: 32nd surface

| | | | | | |
|---|---|---|---|---|---|
| K: | 1.0000 | | | | |
| A4: | 1.48261E−05 | A6: | 8.77718E−08 | A8: | 2.97989E−10 |
| A10: | −9.31413E−13 | | | | |

ASP: 33rd surface

| | | | | | |
|---|---|---|---|---|---|
| K: | 1.0000 | | | | |
| A4: | 2.17627E−05 | A6: | 8.04358E−08 | A8: | 2.99418E−10 |
| A10: | −8.62499E−13 | | | | |

[Focal length data of groups]

| Groups | Starting surfaces | Focal lengths |
|---|---|---|
| f1 | 1 | 242.287 |
| f2 | 6 | −21.345 |
| f4 | 30 | −42.099 |

[Variable distance data]

| | W | M | T |
|---|---|---|---|
| D5 | 2.000 | 22.941 | 28.574 |
| D12 | 15.558 | 5.125 | 2.000 |
| D2 9 | 5.287 | 4.827 | 4.760 |

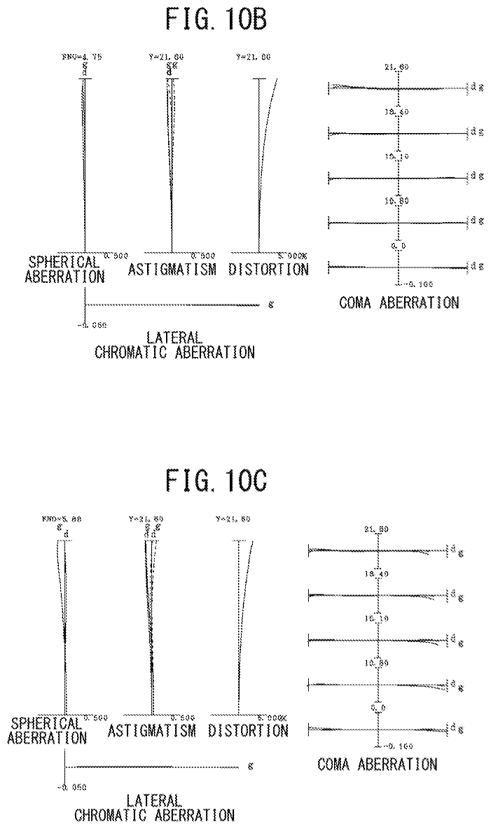

FIG. 10A illustrates aberrations of the variable magnification optical system of the fifth example in the wide-angle end state. FIG. 10B illustrates aberrations of the variable magnification optical system of the fifth example in an intermediate focal length state. FIG. 10C illustrates aberrations of the variable magnification optical system of the fifth example in the telephoto end state.

The graphs of aberrations suggest that the variable magnification optical system of the present example effectively reduces variations in aberrations at focusing and has high optical performance.

A small-sized variable magnification optical system of favorable optical performance can be achieved according to the above examples.

The following are a list of the conditional equations and the values for the conditional equations in the examples.

fF denotes the focal length of the focusing lens group adjacent to the final lens group, and fR denotes the focal length of the final lens group. fRI denotes the focal length of a lens in the final lens group including a lens surface having a pole. k denotes the height of the pole from an optical axis, h denotes the effective radius of the lens surface having a pole. νR denotes the Abbe number of one of lenses in the final lens group including a lens surface having a pole, and νR1 denotes the Abbe number of a lens closest to the image side of lenses in the final lens group including a lens surface having a pole.

| | [List of conditional equations] |
|---|---|
| (1) | TL/fw |
| (2) | fRI/fR |
| (3) | fF/fR |
| (4) | fRI/fw |
| (5) (6) | k/h |
| (7) | BFw/fw |
| (8) | vR |
| (9) | vR1 |

[Values for conditional equations]

| | Example 1 | Example 2 | Example 3 | Example 4 | Example 5 |
|---|---|---|---|---|---|
| (1) | 6.402 | 5.444 | 3.140 | 5.201 | 5.201 |
| (2) | 0.902 | 0.899 | 0.964 | 0.837 | 1.068 |
| | 0.702 | 2.522 | −1.492, | 1.713 | 1.032 |
| | | | 0.927, | | |
| | | | −2.219 | | |
| (3) | 1.345 | 2.299 | 1.021 | 3.269 | 3.362 |
| (4) | 2.206, | 1.545, | 0.906, | 1.867, | 1.820, |
| | 1.715 | 4.322 | 1.402, | 3.819 | 1.759 |
| | | | 0.871, | | |
| | | | 2.084 | | |
| (5) (6) | 0.803, | 0.858, | 0.565, | 0.860, | 0.960, |
| | 0.728 | 0.850 | 0.980, | 0.832 | 0.893 |
| | | | 0.496, | | |
| | | | 0.736, | | |
| | | | 0.979 | | |
| (7) | 0.474 | 0.464 | 0.259 | 0.464 | 0.464 |
| (8) | 61.13, | 45.71, | 49.26, | 42.13, | 40.69, |
| | 45.76 | 46.59 | 53.20, | 37.55 | 33.79 |
| | | | 61.22, | | |
| | | | 18.90 | | |
| (9) | 61.13 | 45.71 | 49.26 | 42.13 | 40.69 |

The above examples illustrate specific examples of the present invention, and the present invention is not limited thereto. The following details can be appropriately employed unless the optical performance of the variable magnification optical system of the embodiment of the present application is lost.

The lens surfaces of the lenses constituting any of the variable magnification optical systems of the above examples may be covered with antireflection coating having high transmittance in a wide wavelength range. This reduces flares and ghosts, and enables achieving optical performance with high contrast.

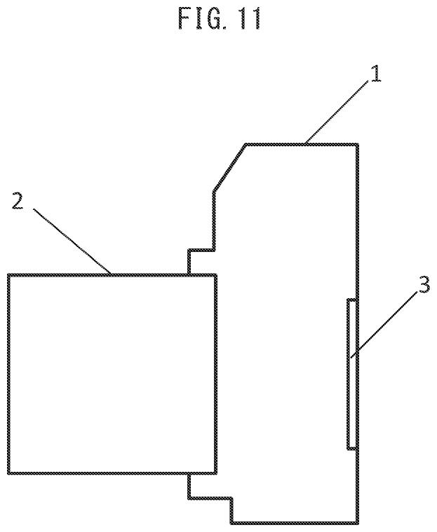

Next, a camera including the variable magnification optical system of the present embodiment is described with reference to FIG. 11.

FIG. 11 schematically illustrates a camera including the variable magnification optical system of the present embodiment.

The camera 1 is a “mirror-less camera” of an interchangeable lens type including the variable magnification optical system according to the first example as an imaging lens 2.

In the camera 1, light from an object (subject) (not shown) is condensed by the imaging lens 2, and reaches an imaging device 3. The imaging device 3 converts the light from the subject to image data.

When a release button (not shown) is pressed by a photographer, the image data is stored in a memory (not shown). In this way, the photographer can take a picture of the subject with the camera 1.

The variable magnification optical system of the first example mounted on the camera 1 as the imaging lens 2 is a small-sized variable magnification optical system of favorable optical performance. Thus the camera 1 can be small and achieve favorable optical performance. When a camera is configured by including any one of the variable magnification optical systems of the second to fifth examples as the imaging lens 2, the camera can have the same effect as the camera 1.

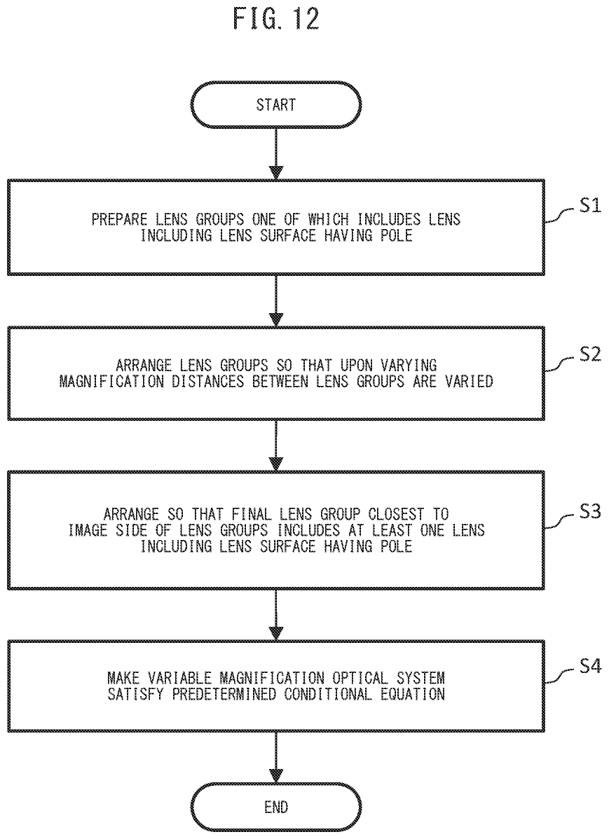

Finally, a method for manufacturing a variable magnification optical system of the present embodiment is briefly described with reference to FIG. 12.

FIG. 12 is a schematic flowchart of a method for manufacturing a variable magnification optical system of the present embodiment.

The method for manufacturing a variable magnification optical system of the present embodiment shown in FIG. 12 is a method for manufacturing a variable magnification optical system including a plurality of lens groups, and includes the following steps S1, S2, S3, and S4:

Step S1: preparing Lens groups one of which includes a lens surface having a pole;

Step S2: arranging the lens groups so that upon varying magnification the distances between the lens groups are varied;

Step S3: arranging so that a final lens group closest to an image side of the lens groups includes at least one lens including a lens surface having a pole; and

Step S4: arranging so that the variable magnification optical system satisfies the following conditional equation (1):

0.50<TL/fw<10.00 (1)

where

TL denotes the shorter of the total optical length in a wide-angle end state and the total optical length in a telephoto end state of the variable magnification optical system, and

fw denotes the focal length of the variable magnification optical system in the wide-angle end state.

A small-sized variable magnification optical system of favorable optical performance can be manufactured by the method for manufacturing a variable magnification optical system of the present embodiment.

Note that those skilled in the art can make various changes, substitutions, and modifications without departing from the spirit and scope of the present invention.

### REFERENCE SIGNS LIST

S aperture stop
I image plane
1 camera
2 imaging lens
3 imaging device

1. A variable magnification optical system comprising a plurality of lens groups, wherein
upon varying magnification the distances between the lens groups are varied,
a final lens group closest to an image side of the lens groups includes at least one lens surface having a pole, and
the following conditional expression is satisfied:
0.50<TL/fw<10.00
where
TL denotes the shorter of the total optical length in a wide-angle end state and the total optical length in a telephoto end state of the variable magnification optical system, and
fw denotes the focal length of the variable magnification optical system in the wide-angle end state.

2. A variable magnification optical system comprising a plurality of lens groups, wherein
upon varying magnification the distances between the lens groups are varied,
a final lens group closest to an image side of the lens groups includes at least one lens surface having a pole, and
the following conditional expression is satisfied:
−5.00<fRI/fR<5.00
where
fRI denotes the focal length of a lens in the final lens group including a lens surface having a pole, and
fR denotes the focal length of the final lens group.

3. The variable magnification optical system according to claim 2, wherein the following conditional expression is satisfied:
0.50<TL/fw<10.00
where
TL denotes the shorter of the total optical length in a wide-angle end state and the total optical length in a telephoto end state of the variable magnification optical system, and
fw denotes the focal length of the variable magnification optical system in the wide-angle end state.

4. The variable magnification optical system according to claim 1, wherein the lens groups include at least one focusing lens group having positive refractive power and configured to move in the direction of an optical axis at focusing.

5. The variable magnification optical system according to claim 4, wherein one of the at least one focusing lens group is adjacent to the final lens group.

6. The variable magnification optical system according to claim 4, wherein the following conditional expression is satisfied:
0.30<|fF/fR|<5.00
where
fF denotes the focal length of the focusing lens group adjacent to the final lens group, and
fR denotes the focal length of the final lens group.

7. The variable magnification optical system according to claim 4, further comprising an aperture stop, wherein the lens groups comprise a front group including one or more lens groups closer to an object side than the aperture stop; a rear group placed closer to the image side than the aperture stop, including the focusing lens group, and having positive refractive power; and the final lens group placed closer to the image side than the rear group and having negative refractive power.

8. The variable magnification optical system according to claim 1, wherein the final lens group comprises a plurality of lenses respectively including lens surfaces having a pole,
of the lens surfaces having a pole, at least two lens surfaces are adjacent to each other with an air layer in between, and
the radii of curvature of the two lens surfaces adjacent to each other with an air layer in between have the same sign on an optical axis.

9. The variable magnification optical system according to claim 1, wherein a final lens in the final lens group closest to the image side includes a lens surface having a pole.

10. The variable magnification optical system according to claim 1, wherein the following conditional expression is satisfied:
0.20<|fRI/fw|<5.00
where
fRI denotes the focal length of a lens in the final lens group including a lens surface having a pole, and
fw denotes the focal length of the variable magnification optical system in the wide-angle end state.

11. The variable magnification optical system according to claim 1, wherein one of the at least one lens surface in the final lens group having a pole satisfies the following conditional expression:
0.10<k/h<1.00
where
k denotes the height of the pole from an optical axis, and
h denotes the effective radius of the lens surface having a pole.

12. The variable magnification optical system according to claim 11, wherein a lens surface closest to the image side of the at least one lens surface in the final lens group having a pole satisfies the following conditional expression:
0.40<k/h<1.00.

13. The variable magnification optical system according to claim 1, wherein the following conditional expression is satisfied:
0.10<BFw/fw<1.00
where
BFw denotes the back focus of the variable magnification optical system in the wide-angle end state, and
fw denotes the focal length of the variable magnification optical system in the wide-angle end state.

14. The variable magnification optical system according to claim 1, wherein the following conditional expression is satisfied:
29.00<νR
where
νR denotes the Abbe number of one of lenses in the final lens group including a lens surface having a pole.

15. The variable magnification optical system according to claim 14, wherein the following conditional expression is satisfied:
29.00<νR1
where
νR1 denotes the Abbe number of a lens closest to the image side of lenses in the final lens group including a lens surface having a pole.

16. An optical apparatus equipped with the variable magnification optical system according to claim 1.

17. A method for manufacturing a variable magnification optical system comprising a plurality of lens groups, the method comprising:
arranging the lens groups so that upon varying magnification the distances between the lens groups are varied;
arranging so that a final lens group closest to an image side of the lens groups includes at least one lens surface having a pole; and
further comprising one of the following features A and B, wherein
the feature A comprises:
arranging so that the following conditional expression is satisfied:
0.50<TL/fw<10.00
where
TL denotes the shorter of the total optical length in a wide-angle end state and the total optical length in a telephoto end state of the variable magnification optical system, and
fw denotes the focal length of the variable magnification optical system in the wide-angle end state, and
the feature B comprises:
arranging so that the following conditional expression is satisfied:
−5.00<fRI/fR<5.00
where
fRI denotes the focal length of a lens in the final lens group including a lens surface having a pole, and
fR denotes the focal length of the final lens group.

18. (canceled)

19. The variable magnification optical system according to claim 2, wherein the lens groups include at least one focusing lens group having positive refractive power and configured to move in the direction of an optical axis at focusing, and the following conditional expression is satisfied:
0.30<|fF/fR|<5.00
where
fF denotes the focal length of the focusing lens group adjacent to the final lens group.

20. The variable magnification optical system according to claim 2, wherein the final lens group comprises a plurality of lenses respectively including lens surfaces having a pole,
of the lens surfaces having a pole, at least two lens surfaces are adjacent to each other with an air layer in between, and
the radii of curvature of the two lens surfaces adjacent to each other with an air layer in between have the same sign on an optical axis.

21. The variable magnification optical system according to claim 2, wherein a final lens in the final lens group closest to the image side includes a lens surface having a pole.

22. The variable magnification optical system according to claim 2, wherein the following conditional expression is satisfied:
0.20<|fRI/fw|<5.00
where
fw denotes the focal length of the variable magnification optical system in the wide-angle end state.

23. The variable magnification optical system according to claim 2, wherein one of the at least one lens surface in the final lens group having a pole satisfies the following conditional expression:
0.10<k/h<1.00
where
k denotes the height of the pole from an optical axis, and
h denotes the effective radius of the lens surface having a pole.

24. The variable magnification optical system according to claim 23, wherein a lens surface closest to the image side of the at least one lens surface in the final lens group having a pole satisfies the following conditional expression:
0.40<k/h<1.00.

25. The variable magnification optical system according to claim 2, wherein the following conditional expression is satisfied:
0.10<BFw/fw<1.00
where
BFw denotes the back focus of the variable magnification optical system in the wide-angle end state, and
fw denotes the focal length of the variable magnification optical system in the wide-angle end state.

26. The variable magnification optical system according to claim 2, wherein the following conditional expression is satisfied:
29.00<νR
where
νR denotes the Abbe number of one of lenses in the final lens group including a lens surface having a pole.

27. The variable magnification optical system according to claim 26, wherein the following conditional expression is satisfied:
29.00<νR1
where
νR1 denotes the Abbe number of a lens closest to the image side of lenses in the final lens group including a lens surface having a pole.
